(19) United States
(12) Patent Application Publication
(10) Pub. No.: US 2017/0091521 A1
(43) Pub. Date: Mar. 30, 2017

(54) SECURE VISUAL FEEDBACK FOR FINGERPRINT SENSING

(71) Applicant: Synaptics Incorporated, San Jose, CA (US)

(72) Inventor: Kinh Tieu, San Jose, CA (US)

(21) Appl. No.: 14/871,151

(22) Filed: Sep. 30, 2015

(51) Int. Cl. G06K 9/00; G06K 9/48; G06K 9/03; G06K 9/46; G06K 9/34

(52) U.S. Cl. CPC G06K 9/00067; G06K 9/00033; G06K 9/00087; G06K 9/4652; G06K 9/34; G06K 9/036; G06K 9/48

(57) ABSTRACT

Systems and methods for providing visual feedback to a user during fingerprint acquisition. An abstract image or feedback image including a visual representation of the shape of the currently acquired part of the finger is displayed, which provides implicit feedback to the user as to what portion of the fingerprint may be missing. The feedback image also includes a visualization representing a quality of the image, which implicitly alerts the user as to potential problems with the fingerprint presented and imaged. The implicit feedback encourages the user, without explicit prompts, as to how to move the finger to help improve fingerprint coverage or to adjust the quality of the fingerprint presented.

### FIELD OF THE DISCLOSURE

This invention generally relates to biometric recognition, and more particularly to fingerprint recognition.

### BACKGROUND OF THE DISCLOSURE

Biometric authentication systems are used for enrolling and verifying users of devices incorporating the authentication systems. Biometric sensing technology provides a reliable, non-intrusive way to verify individual identity for authentication purposes.

Fingerprints, like certain other biometric characteristics, are based on unalterable personal characteristics and thus are a reliable mechanism to recognize individuals. There are many potential applications for utilization of biometric and fingerprints sensors. For example, electronic fingerprint sensors may be used to provide access control in stationary applications, such as security checkpoints. Electronic fingerprint sensors may also be used to provide access control in portable applications, such as portable computers, personal data assistants (PDAs), cell phones, gaming devices, navigation devices, information appliances, data storage devices, and the like. Accordingly, some applications, in particular portable applications, may require electronic fingerprint sensing systems that are compact, highly reliable, and inexpensive.

Fingerprint sensors are sometimes referred to as “swipe” sensors or “placement” sensors depending on their principle of operation. Typically, swipe sensors capture an image that is larger than the sensing area by capturing a series of scans of the fingerprint as the user swipes her finger over the sensing area. A processing system then reconstructs the scans into a larger swipe image. Since the image is reconstructed from a series of scans, this allows the sensing array to be made small, even as small as a single scan line, while still capturing a larger area image. Placement sensors typically capture an image that corresponds to the size of the sensing area by capturing scans of the fingerprint as it is placed or otherwise held over the sensing area. Usually, placement sensors include a two dimensional sensor array that can capture a sufficient area of the fingerprint in a single scan, allowing the fingerprint image to be captured without the user having to move the finger during the image capture process.

As fingerprint sensors shrink in size, whether for the purpose of packaging them into smaller portable devices, to reduce cost, or for other reasons, accurate and usable fingerprint recognition becomes a challenging task. The fingerprint recognition system should capture a sufficient area of the fingerprint to discriminate between different users. It is possible for a swipe sensor to capture a much larger area of the fingerprint than the sensor size, allowing the fingerprint sensor to be made small while still capturing a larger area swipe fingerprint image with enough fingerprint information to easily discriminate between users. Unfortunately, some users find the process of swiping their finger over the sensor every time they want to access the system to be cumbersome.

Placement sensors provide an attractive solution for many users, since they allow the user to simply hold her finger over the sensor. However, there are several technical challenges with small placement sensors that only capture a partial fingerprint image. Because only a partial area of the fingerprint that corresponds to the size of the sensor is captured, the matching process should ideally be tailored to quickly and accurately match based on limited fingerprint information, a task for which conventional matching algorithms based on full fingerprint images are often poorly equipped. Furthermore, since the sensor is only large enough to capture a partial fingerprint image during placement, in ordinary use the user is likely to present different portions of the same fingerprint on different occasions when attempting to access the system. The recognition system should ideally be able to recognize the fingerprint without requiring the user to present the same small portion of the fingerprint every time.

To achieve this, an enrollment template is typically built up that is derived from several repeated placements of the fingerprint over the sensor. This process often still results in a low quality enrollment template, since the user is provided little guidance as to where to place the fingerprint, resulting in poor coverage of the fingerprint in the enrollment template. Furthermore, determining the geometric relationship between the separate placement views is a challenging task, particularly where multiple views are captured from non-overlapping portions of the fingerprint.

Once a fingerprint is enrolled, the fingerprint enrollment template stored to the system may be used to authenticate a user attempting to access the system. Authentication generally involves matching a fingerprint presented for access to the system with the fingerprint template stored to the system. However, fingerprint authentication often fails, not because of the performance of matching method, but because the user has provided a poor quality fingerprint image. For example, the user may accidentally present only a portion of the finger instead of covering the entire sensor, or there may be a blemish affecting the quality of the fingerprint presented. This limits the amount of fingerprint information acquired and provided to the matcher method and will often result in a false rejection.

### BRIEF SUMMARY OF THE DISCLOSURE

The present disclosure provides systems and methods for providing visual feedback to a user during fingerprint acquisition. The methods provided are particularly useful as part of an authentication process. An abstract image or feedback image including a visual representation of the shape of the currently acquired part of the finger is displayed, which provides implicit feedback to the user as to what portion of the fingerprint may be missing. The feedback image also includes a visualization representing a quality of the image, which implicitly alerts the user as to potential problems with the fingerprint presented and imaged. The implicit feedback encourages the user, without explicit prompts, as to how to move the finger to help improve fingerprint coverage or to adjust the quality of the fingerprint presented. Without feedback, the user may repeatedly provide the same poor quality fingerprint image and ultimately become frustrated and switch to another modality for authentication.

One embodiment provides an electronic device including a fingerprint sensor, a display; and a processing system communicably coupled with the fingerprint sensor and the display. The processing system is configured to acquire an image of a fingerprint from the fingerprint sensor, segment the image of the fingerprint into a segmented image having a fingerprint pattern region and a non-fingerprint pattern region, and generate a feedback image. The feedback image includes a visualization of an imaging area of the fingerprint sensor and a visualization of at least the fingerprint pattern region of the segmented image, the visualization of the fingerprint pattern region being positioned within the visualization of the imaging area at a location that corresponds to a position of the fingerprint relative to the imaging area of the fingerprint sensor. The processing system is also configured to render or display the feedback image on the display. In certain aspects, the fingerprint sensor includes a partial fingerprint sensor configured to obtain a swipe image of a user's fingerprint. The swipe image is captured while the user's fingerprint is moved over a sensing area of the partial fingerprint sensor.

Another embodiment includes a method of providing visual feedback for fingerprint sensing. The method includes acquiring an image of a fingerprint from a fingerprint sensor of an electronic device. The method further includes segmenting the image of the fingerprint into a segmented image having a fingerprint pattern region and a non-fingerprint pattern region. The method further includes generating a feedback image that includes a visualization of an imaging area of the fingerprint sensor and a visualization of at least the fingerprint pattern region of the segmented image, where the visualization of the fingerprint pattern region is positioned within the visualization of the imaging area at a location that corresponds to a position of the fingerprint relative to the imaging area of the fingerprint sensor. The method further includes displaying or rendering the feedback image on a display of the electronic device.

Yet another embodiment includes an electronic system for providing visual feedback during a process of sensing a fingerprint with a fingerprint sensor. The electronic system includes a processing system configured to receive an image of the fingerprint from a fingerprint sensor. The processing system is further configured to segment the image of the fingerprint into a segmented image having a fingerprint pattern region and a non-fingerprint pattern region. The processing system is further configured to generate a feedback image for rendering on a display device, where the feedback image includes a visualization of an imaging area of the fingerprint sensor and a visualization of at least the fingerprint pattern region of the segmented image, where the visualization of the fingerprint pattern region is positioned within the visualization of the imaging area at a location that corresponds to a position of the fingerprint relative to the imaging area of the fingerprint sensor.

### BRIEF DESCRIPTION OF THE DRAWING(S)

The accompanying drawings incorporated in and forming a part of the specification illustrate several aspects of the present disclosure and, together with the description, serve to explain the principles of the disclosure. In the drawings:

FIG. 1 is a block diagram of an exemplary device that includes an input device and processing system, in accordance with an embodiment of the disclosure;

FIG. 2a is an image of a fingerprint;

FIG. 2b is an enhanced image of the fingerprint of FIG. 2a;

FIG. 3 is an illustration of various types of minutiae points of a fingerprint;

FIG. 4 is an image of a fingerprint;

FIG. 5 is a thin-ridge version of the fingerprint of FIG. 4;

FIG. 6 illustrates examples of visual feedback images displayed according to an embodiment; and

FIG. 7 illustrates a flow chart for providing visual feedback to a user while sensing the user's fingerprint according to an embodiment.

### DETAILED DESCRIPTION OF THE DISCLOSURE

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present disclosure provide input devices and methods that facilitate improved usability.

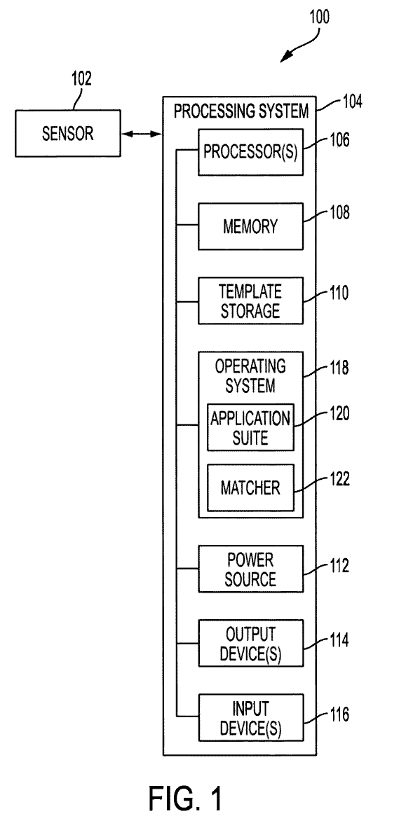

Turning now to the figures, FIG. 1 is a block diagram of an electronic system or device 100 that includes an input device such as sensor 102 and processing system 104, in accordance with an embodiment of the disclosure. As used in this document, the term “input device” and “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic devices include composite input devices, such as physical keyboards and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic device 100 could be a host or a slave to the sensor 102.

Sensor 102 can be implemented as a physical part of the electronic device 100, or can be physically separate from the electronic device 100. For example, sensor elements of sensor 102 may be integrated in a display device that is itself implemented as a physical part of the electronic device 100 or communicably coupled with the electronic device 100. As appropriate, the sensor 102 may communicate with parts of the electronic device 100 using any one or more of the following communication interconnections: buses, networks, and other wired or wireless interconnections. Examples include I²C, SPI, PS/2, Universal Serial Bus (USB), Bluetooth, RF, and IRDA.

Generally, sensor 102 will be utilized as a fingerprint sensor utilizing one or more various electronic fingerprint sensing methods, techniques and devices to capture a fingerprint image of a user. Generally, fingerprint sensor 102 may utilize any type of technology to capture a user's fingerprint. For example, in certain embodiments, the fingerprint sensor 102 may be an optical, capacitive, thermal, pressure, radio frequency (RF) or ultrasonic sensor.

In some embodiments, the sensor 102 is a capacitive fingerprint sensor, with the traces that form a 2D grid array, e.g., with rows of transmitter/receiver traces on one substrate and columns of receiver/transmitter traces on the same or a separate substrate, e.g., laminated together with some form of dielectric between the traces to form a 2D sensor element array.

Furthermore, biometric image sensors, such as fingerprint sensors, are sometimes referred to as “swipe” sensors or “placement” sensors depending on their principle of operation. Typically, swipe sensors capture an image that is larger than the sensing area by capturing a series of scans of the fingerprint as the user swipes their finger over the sensing area. In some applications, a processing system may reconstruct the scans into a larger swipe image. Since the image may be reconstructed from a series of scans, this allows the sensing array to be made small, even as small as a single scan line, while still capturing a larger area image. In some applications, a larger image area can be stored as a series of scans using a map or mapping function that correlates the various scan images. Placement sensors typically capture an image that corresponds to the size of the sensing area by capturing scans of the fingerprint as it is placed or otherwise held over the sensing area. Usually, placement sensors include a two dimensional sensor array that can capture a sufficient area of the fingerprint in a single scan, allowing the fingerprint image to be captured without the user having to move the finger during the image capture process.

Placement sensors have an active sensing surface or in other terms, sensing area, that is large enough to accommodate a portion of the relevant part of the fingerprint of the finger during a single scan or sensing action. Where the relevant part of the fingerprint is less than the full fingerprint, this is referred to herein as a “partial” fingerprint sensor. Partial fingerprint placement sensors can be made very small and still reliably recognize fingerprints with sophisticated matching schemes, but typically matching performance is affected by the quality of the enrollment template being matched against. In one embodiment of this disclosure, a partial fingerprint sensor is used with a sensing area less than approximately 50 square mm. In another embodiment, a partial fingerprint sensor is used with a sensing area less than approximately 30 square mm. Typically, for placement sensors, the finger is held stationary over the sensing area during a measurement. During a fingerprint enrollment process, multiple views of the fingerprint image may be captured.

Generally, swipe sensors can be made smaller in size than placement sensors that capture an equivalent fingerprint area, and require the finger to be moved over the sensor during a measurement. Typically, the finger movement will be either 1D in that the finger moves in a single direction over the sensor surface, or the finger movement can be 2D in that the finger can move in more than one direction over the sensor surface during a measurement. In certain embodiments of this disclosure, a placement sensor may be operated in a swipe mode. In these embodiments, a placement sensor may capture a swipe image by capturing a series of scans during relative motion between the sensor array and the user's fingerprint, and the series of scans are reconstructed into a larger area swipe image. In one implementation, the placement sensor captures the scans using its entire sensor array. In another implementation, the placement sensor looks to only a subset of pixels in its sensor array, such as one or two scan lines, when capturing the swipe image.

Turning now to the processing system 104 from FIG. 1, basic functional components of the electronic device 100 utilized during capturing and storing a user fingerprint image are illustrated. The processing system 104 includes a processor 106, a memory 108, a template storage 110, a power source 112, an output device(s) 114, an input device(s) 116 and an operating system (OS) 118 hosting an application suite 120 and a matcher 122. In certain embodiments, output device(s) 114 and input device(s) 116 are separate from, yet communicably coupled with, processing system 104. For example, each of output device(s) 114 and input device(s) 116 may communicate with processing system 104 wirelessly or via a wired connection. Each of the processor 106, the memory 108, the template storage 110, the power source 112, the output device(s) 114, the input device(s) 116 and the operating system 118 are interconnected physically, communicatively, and/or operatively for inter-component communications.

As illustrated, processor(s) 106 is configured to implement functionality and/or process instructions for execution within electronic device 100 and the processing system 104. For example, processor 106 executes instructions stored in memory 108 or instructions stored on template storage 110. Memory 108, which may be a non-transitory, computer-readable storage medium, is configured to store information within electronic device 100 during operation. In some embodiments, memory 108 includes a temporary memory, an area for information not to be maintained when the electronic device 100 is turned off. Examples of such temporary memory include volatile memories such as random access memories (RAM), dynamic random access memories (DRAM), and static random access memories (SRAM). Memory 108 also maintains program instructions for execution by the processor 106.

Template storage 110 comprises one or more non-transitory computer-readable storage media. The template storage 110 is generally configured to store enrollment data such as enrollment views for fingerprint images for a user's fingerprint. The template storage 110 may further be configured for long-term storage of information. In some examples, the template storage 110 includes non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The processing system 104 includes one or more power sources 112 to provide power to the electronic device 100. Non-limiting examples of power source 112 include single-use power sources, rechargeable power sources, and/or power sources developed from nickel-cadmium, lithium-ion, or other suitable material.

The processing system 104 includes one or more input devices 116, and/or is communicably coupled with one or more input devices 116. Input devices 116 are configured to receive input from a user or a surrounding environment of the user through tactile, audio, and/or video feedback. Non-limiting examples of input device 116 include a presence-sensitive screen, a mouse, a keyboard, a voice responsive system, video camera, microphone or any other type of input device. In some examples, a presence-sensitive screen includes a touch-sensitive screen. In certain embodiments, the sensor 102 may be included as an input device 116.

The processing system 104 includes one or more output devices 114, and/or is communicably coupled with one or more output devices 114. Output devices 114 are configured to provide output to a user using tactile, audio, and/or video stimuli. Output device 114 may include a display screen (e.g., part of the presence-sensitive screen), a sound card, a video graphics adapter card, or any other type of device for converting a signal into an appropriate form understandable to humans or machines. Additional examples of output device 114 include a speaker such as headphones, a cathode ray tube (CRT) monitor, a liquid crystal display (LCD), or any other type of device that can generate intelligible output to a user.

The processing system 104 also hosts an operating system 118. The operating system 118 controls operations of the components of the processing system 104. For example, the operating system 118 facilitates the interaction of the processor(s) 106, memory 108, template storage 110, power source 112, output devices 114 and input devices 116. The operating system 118 further hosts the application suite 120. The application suite 120 contains applications utilizing data stored on the memory 108 or the template storage 110 or data collected from input devices 112 or the sensor 102 to cause the processing system 104 to perform certain functions. For instance, in certain embodiments, the application suite 120 hosts an enroller application, which functions to capture one or more views of the user's fingerprint. The views or fingerprint images generally contain a partial or full image of the user's fingerprint. The enrollment application instructs, either explicitly or implicitly, the user to hold or swipe their finger across the sensor 102 for capturing or acquiring the image of the fingerprint. After each requested image is captured, the enrollment application typically stores the captured image in the template storage 110. In certain embodiments, the enrollment application will cause the data representing the captured image to undergo further processing. For instance, the further processing may be to compress the data representing the captured image such that it does not take as much memory within the template storage 110 to store the image.

In certain embodiments, the application suite 120 will also contain applications for authenticating a user of the electronic device 100. For example, these applications may be an OS logon authentication application, a screen saver authentication application, a folder/file lock authentication application, an application lock and a password vault application. In each of these applications, the individual application will cause the operating system 118 to request the user's fingerprint for an authentication process prior to undertaking a specific action, such as providing access to the OS 118 during a logon process for the electronic device 100. To perform this process, the above listed applications will utilize the matcher 122 hosted by the operating system 118.

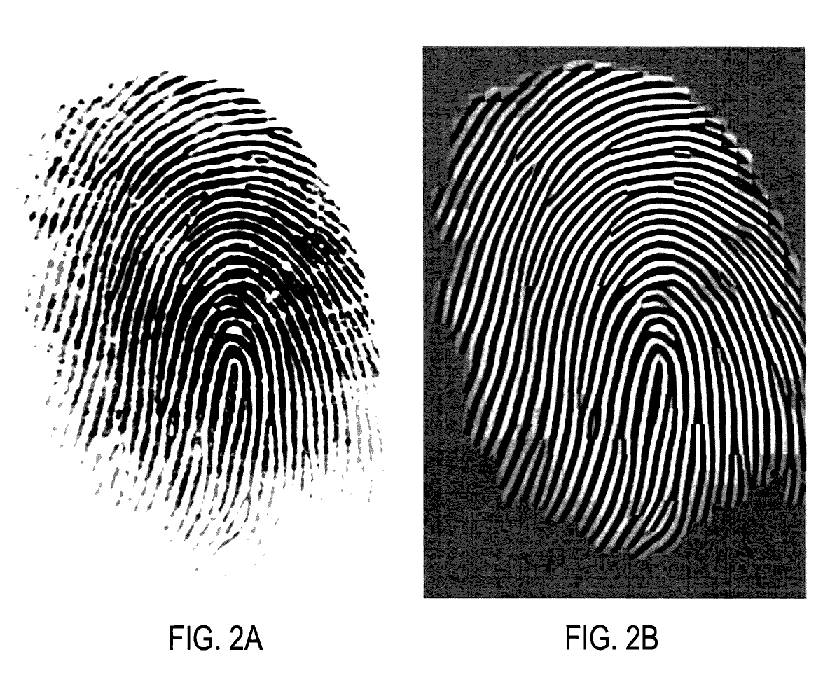

The matcher 122 of the operating system 118 functions to compare the fingerprint image or images stored in the template storage 110 with a newly acquired fingerprint image or images from a user attempting to access the electronic device 100. In some embodiments, the matcher 122 will also function to compare fingerprint images collected during the enrollment process such that the collected fingerprint images may be grouped to form the enrollment template. In certain embodiments, the matcher 122 will further perform image enhancement functions for enhancing a fingerprint image. An example of the image enhancement function is illustrated in FIGS. 2a and 2b. FIG. 2a illustrates an unenhanced fingerprint image that shows various ridges and minutia of a fingerprint. As can be seen in FIG. 2a, the image is noisy such that portions of the image are cloudy and the ridges or contours are broken. FIG. 2b illustrates the same fingerprint after the matcher 122 has performed the image enhancement function. As can be seen, the image enhancement function removes much of the noise such that the image is no longer cloudy and the ridges are no longer broken.

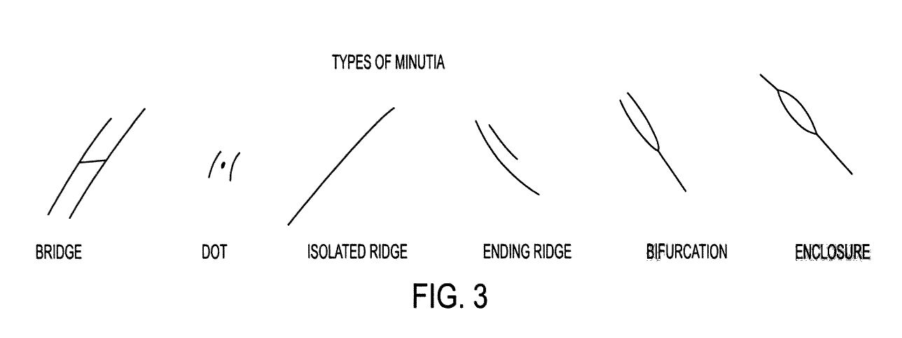

In certain embodiments, the matcher 122 is also configured to perform feature extraction from the fingerprint image or images of the user. During feature extraction, the matcher 122 will extract unique features of the user's fingerprint to utilize during authentication. There are a variety of approaches to matching fingerprint images, which include minutia matching and pattern matching schemes. If recognition is performed using minutia matching, the matcher 122 will scan the captured view of the user's fingerprint for minutia. FIG. 3 illustrates various types of fingerprint minutia, including a bridge point between two or more ridges, a dot, an isolated ridge, an ending ridge, a bifurcation point and an enclosure. During extraction, the matcher 122 acquires a location and orientation of the minutia from the fingerprint and compares it to previously captured location and orientation information of minutia from the fingerprint image or images in the template storage 110. If certain threshold criteria are met, then the matcher 122 indicates a match, otherwise, no match is indicated.

In certain embodiments, the matcher 122 may be configured to perform pattern matching. Whereas minutia matching typically needs only the minutia points, with their respective locations and orientations, pattern matching utilizes a more complete representation of the fingerprint. Examples of pattern matching include ridge matching, which compares skeletonized representations of fingerprint contours to each other, and ridge flow matching, which compares contour orientation information to perform matching. If certain threshold criteria are met, then the matcher 122 indicates a match, otherwise, no match is indicated.

Regardless of whether minutia matching or pattern matching is utilized by the matcher 122, one or more views of the user's fingerprint(s) are stored in the template storage 110 during the enrollment process of the application suite 120. In order to facilitate matching, the one or more views of the user's fingerprint(s) are stored in a way that facilitates matching with fingerprint views captured during the authentication process. In this regard, the location and orientation of minutia and/or ridge curvature and/or ridge density are stored in the template storage 110.

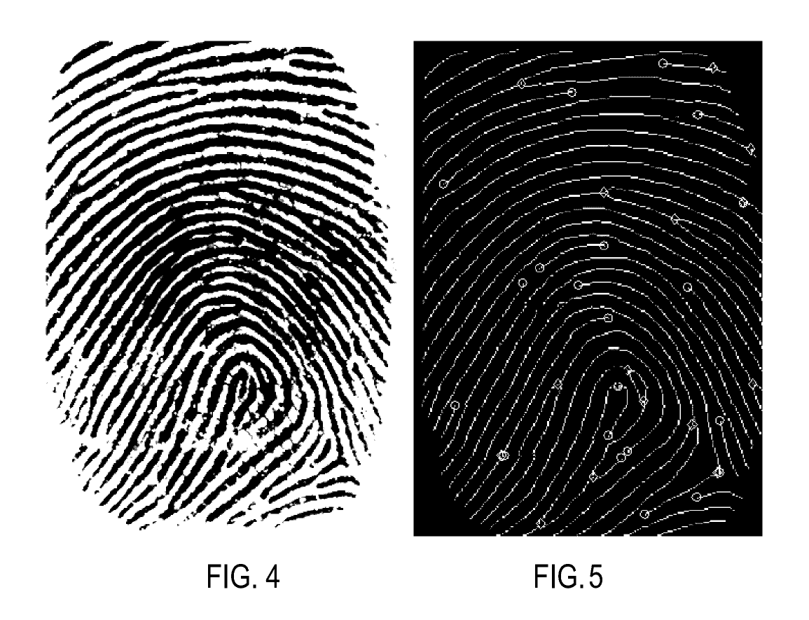

FIG. 4 depicts an example of a grayscale fingerprint image as captured from a sensor 102. FIG. 5 depicts a skeletonized (also referred to as “thin-ridge”) representation of the fingerprint image in FIG. 4. FIG. 5 also depicts minutia points overlaid on the skeletonized image. If minutia matching is used, feature extraction may involve conversion of the raw image to the skeletonized image, and derivation of the minutia points from the skeletonized image. In another minutia matching implementation, the minutia points can be extracted from a grayscale image. In a ridge matching implementation, the skeletonized image itself may be used as the features of interest, in which case matching can be performed based on the a difference metric, such as chamfer distance, between ridges in the images. In such a ridge matching implementation, as well as certain other pattern matching implementations, the location and orientation of the minutia points may not be needed for matching.

Additionally, in embodiments where the sensor 102 (see FIG. 1) is a partial fingerprint sensor such as a partial placement sensor, due to the size of the sensing area of the sensor 102 typically being smaller than the user's fingerprint area, a multitude of placement images of the user's fingerprint from the placement sensor 102 may be collected to form the enrollment template such that it adequately describes the user's fingerprint. As the multitude of placement images are collected, the enroller function of the application suite 120 calls on the matcher 122 to relate the placement views with each other such that they can be grouped into an accurate composite of the user's fingerprint.

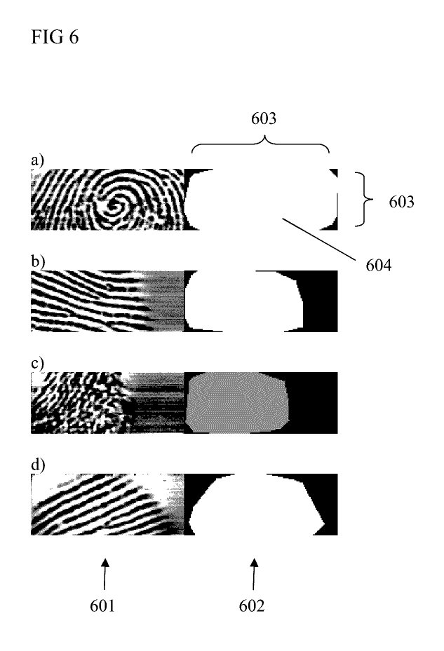

In one embodiment, fingerprint image acquisition, e.g., during authentication, may be aided by providing visual feedback to the user to help maximize or improve coverage of the fingerprint imaged. The visualization is abstract so that no actual fingerprint information is visualized to maintain security of biometric data. For usability the visualization is simple, yet provides implicit feedback to the user as to which parts of the finger are captured by the system to help improve fingerprint coverage. The visualization may include a visual quality measure that provides implicit feedback to the user as to potential problems with the fingerprint presented. The visualization presented to the user is a geometric representation, or blob, of the finger (See FIG. 6, discussed in more detail below, which shows examples of acquired fingerprint images (left column) and corresponding abstract visualization images (right column) displayed to the user). The abstract image provides shape information (the silhouette of the fingerprint) as well as information regarding where on the sensor the fingerprint was located during imaging (position in sensor field of view). Thus, when the tip of the finger is imaged, the user receives a hint that this is so because the corners of the image will be empty. When a portion of the finger is imaged, then the silhouette will only partially cover the image at a position corresponding to the position of the finger on the sensor. Along with shape, the quality of each area of the image can be emphasized, e.g., by displaying a brightness value or color at the corresponding pixel locations of the image. This is useful for example if the finger is dirty, where the user will see the hint that some isolated portions of the fingerprint image have low quality.

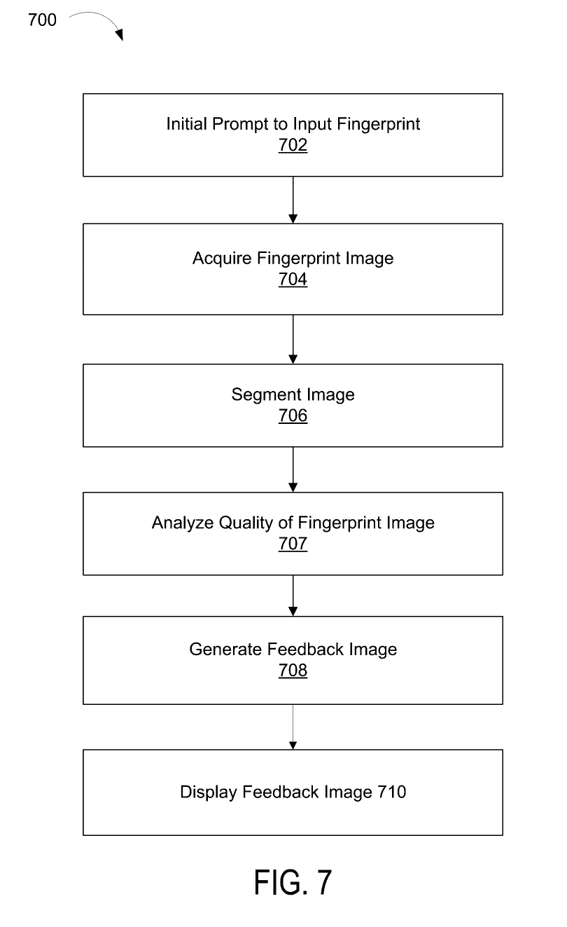

FIG. 7 illustrates a flow chart 700 for providing visual feedback to a user while sensing the user's fingerprint, e.g., for use with fingerprint authentication by the electronic device 100 (see FIG. 1). At step 702, an initial prompt is provided to the user to begin the fingerprint acquisition process. For example, the user may be explicitly instructed to touch or swipe the user's finger on the sensor 102. At step 704, a first image 601 (FIG. 6) of the user's fingerprint is acquired by processing system 104 using sensor 102. The first image (and any subsequent images) may be stored to memory 108 or template storage 110 or elsewhere in the system. At step 706, processing system 104 processes the first image to segment the fingerprint image into a segmented image having a fingerprint pattern region and a non-fingerprint pattern region. For example, the matcher 122, or another component or module of processing system 104, segments off portions of the image known to represent a portion of a fingerprint pattern from portions of the image known to not represent a portion of a fingerprint pattern. In one embodiment, a quality of the image of the fingerprint acquired may be analyzed at optional step 707, which will be discussed in more detail further below.

At step 708, processing system 104 produces or generates a feedback image 602 (FIG. 6). For example, the generated feedback image may include a visualization 603 (FIG. 6) representing an imaging area of the fingerprint sensor 102 and a visualization 604 (FIG. 6) representing the fingerprint pattern region as determined in step 706. For example, the visualization 604 of the fingerprint pattern region is positioned within the visualization 603 of the imaging area of the sensor at a location that corresponds to a position of the fingerprint relative to the imaging area of the fingerprint sensor. In certain aspects, the visualization 604 representing the fingerprint pattern includes a geometric representation of the segmented area or region of the fingerprint captured. In some embodiments, the visualization 604 may include a portion of a synthetic fingerprint corresponding to the region of the user's fingerprint captured. The generated feedback image 602 may be stored to memory 108 or elsewhere in the system. At step 710, the processing system 104 displays or renders the feedback image 602 on the display. The feedback image 602 may be displayed with the same aspect ratio as the field of view of the sensor 102 (e.g., the visualization 603 of the sensor imaging area may have the same aspect ratio as the sensor 102), or with a different aspect ratio. In some embodiments, a blank or similar visualization of the field of view of the sensor 102 is displayed before the visualization containing the fingerprint pattern is displayed.

FIG. 6 illustrates examples of visual feedback images 602 displayed according to an embodiment. The left column shows an example of the acquired fingerprint image 601. The fingerprint images 601 are generally not displayed or provided to the user to maintain security of the biometric data, although a fake fingerprint may be presented in lieu of the real fingerprint image. The right column shows examples of the corresponding secure feedback images 602, including a geometric visualization 603 representing the imaging area of the fingerprint sensor and a geometric visualization 604 representing the captured fingerprint pattern region, presented to the user. The feedback images 602 shown in FIGS. 6a through 6d provide feedback to the user regarding the fingerprint coverage and the quality of the fingerprint coverage. This information implicitly prompts the user as to which part of the finger was imaged and whether the sensor was fully covered. Also, the brightness (example of quality visualization) of the silhouette gives image quality information which can help direct the user to better position her finger for subsequent imaging. Other examples of image quality visualization information might include color gradations (e.g., grayscale gradations or varying colors from red to blue) of the silhouette, varying intensity/flashing of the silhouette, or other emphasis techniques.

In certain aspects, display of a feedback image 602 may occur automatically in response to the user presenting or inputting a fingerprint image for enrollment or verification. In certain aspects, display of a feedback image 602 may occur in response to a match rejection, but may not occur in response to a match acceptance, for example, if the matcher 122 determines that the presented fingerprint matches a fingerprint enrollment template. Display of a feedback image 602 provides the user feedback as to what portion of the fingerprint has been captured and on what region of the sensor. This also implicitly prompts the user to move her finger so that on the next touch or swipe, it is more likely that the user will present a previously unseen part of the fingerprint.

In one embodiment, a quality of the image of the fingerprint acquired may be analyzed at optional step 707. For example, the matcher 122 may analyze the fingerprint image 601 to determine which region or regions of the image have sufficient or insufficient information to be used for fingerprint matching. Insufficient information may be determined for certain regions where the fingerprint includes blurry or noisy features such as fingerprint minutia and fingerprint ridges which may not be readily discernable to the matcher. The matcher will assess the acquired fingerprint image with reference to a generic fingerprint model to determine those regions with reduced quality. A quality score or metric may be assigned to a region having reduced quality. Reduced quality may be a result of a smudge of material on a portion of the fingerprint, or a cut on the finger, low contrast, as examples.

In embodiments where quality analysis is performed at step 707, the feedback image 602 is adjusted to include a visualization of the quality of the fingerprint image at step 708. In certain aspects, the visualization of the quality includes a visual effect representative of the quality in the fingerprint image. For example, the quality visualization may be proportional to the quality (e.g., based on a quality metric). FIG. 6 illustrates visualizations of a fingerprint 601 where brightness of the corresponding visualization 604 of the fingerprint pattern region is proportional to the quality; the brighter the fingerprint pattern region visualization 604, the better the quality. The visualization of the quality may include a color coded representation of the quality. For example, a red visualization may indicate bad or reduced quality whereas a green visualization may indicate good or better quality. Also, a range of colors may be used to represent a range of quality measures, for example, ranging from red to blue along the color spectrum with one extreme representing better quality and the other extreme representing poorer quality. The visualization of the quality may include a varying color or tone, or a varying intensity (e.g., flashing).

In certain aspects the visualization of the quality includes a visual effect representative of a type or dimension of quality degradation in the fingerprint image. For example, a blurriness or contrast quality measure may be displayed in a certain color, and a different quality measure (e.g., indicative of a cut on the finger) may be displayed in a different fashion such as with a variable brightness. In certain aspects, the visualization of the quality includes one or more sub-regions within the visualization of the fingerprint pattern region, with each sub-region including a visual effect representative of the quality of the sub-region and/or a type or dimension of the quality in the sub-region. For example, a first sub-region may be displayed brighter than a second sub-region, indicating that, although the first sub-region has a blemish or reduced quality as compared with other regions of the fingerprint pattern, the first sub-region is of better quality than the second sub-region.

In some embodiments, the feedback image 602 may include an outline or silhouette encompassing the fingerprint pattern region. A silhouette is the image of an object or subject represented as a solid shape of a single color (e.g., white or black) to contrast with the background (e.g., black or white), with its edges or border matching the outline of the object or subject.

It should be appreciated to one skilled in the art that the systems and methods described herein with regard to fingerprint sensing are equally applicable to other biometric pattern sensing modalities using small sensors or which encounter sensing problems requiring repeated biometric pattern entry. For example, other biometric patterns may include, among other possibilities, iris patterns, palm prints, vein patterns, and faces.

The embodiments and examples set forth herein were presented in order to best explain the present disclosure and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An electronic device comprising:
a fingerprint sensor;
a display; and
a processing system communicably coupled with the fingerprint sensor and the display, the processing system configured to:
a) acquire an image of a fingerprint from the fingerprint sensor;
b) segment the image of the fingerprint into a segmented image having a fingerprint pattern region and a non-fingerprint pattern region;
c) generate a feedback image that includes a visualization of an imaging area of the fingerprint sensor and a visualization of at least the fingerprint pattern region of the segmented image, the visualization of the fingerprint pattern region positioned within the visualization of the imaging area at a location that corresponds to a position of the fingerprint relative to the imaging area of the fingerprint sensor; and
d) display the feedback image on the display.

2. The electronic device of claim 1, wherein the feedback image is displayed in response to a match rejection and omitted for a match acceptance.

3. The electronic device of claim 1, wherein the feedback image includes an outline corresponding to a border of the fingerprint pattern region of the segmented image.

4. The electronic device of claim 3, wherein the visualization of the fingerprint pattern region includes a silhouette, and the outline of the feedback image is a border of the silhouette.

5. The electronic device of claim 3, wherein the visualization of the fingerprint pattern region includes a fake fingerprint, and the outline of the feedback image is a border of the fake fingerprint.

6. The electronic device of claim 1, wherein the processing system is further configured to:
analyze a quality of the image of the fingerprint,
wherein the feedback image further includes a visualization of the quality of the fingerprint image.

7. The electronic device of claim 6, wherein the visualization of the quality includes a color coded representation of the quality.

8. The electronic device of claim 6, wherein the visualization of the quality includes a visual effect representative of a type of quality degradation in the fingerprint image.

9. The electronic device of claim 6, wherein the visualization of the quality includes one or more sub-regions within the visualization of the fingerprint pattern region, each sub-region including a visual effect representative of the quality of the sub-region.

10. A method of providing visual feedback for fingerprint sensing, the method comprising:
a) acquiring an image of a fingerprint from a fingerprint sensor of an electronic device;
b) segmenting the image of the fingerprint into a segmented image having a fingerprint pattern region and a non-fingerprint pattern region;
c) generating a feedback image that includes a visualization of an imaging area of the fingerprint sensor and a visualization of at least the fingerprint pattern region of the segmented image, the visualization of the fingerprint pattern region positioned within the visualization of the imaging area at a location that corresponds to a position of the fingerprint relative to the imaging area of the fingerprint sensor; and
d) displaying the feedback image on a display of the electronic device.

11. The method of claim 10, further comprising:
analyzing a quality of the image of the fingerprint image,
wherein the feedback image further includes a visualization of the quality of the fingerprint image.

12. The method of claim 11, wherein the visualization of the quality includes a color coded representation of the quality.

13. The method of claim 11, wherein the visualization of the quality includes one or more sub-regions within the visualization of the fingerprint pattern region, each sub-region including a visual effect representative of the quality of the sub-region.

14. The method of claim 10, wherein the feedback image is displayed in response to a match rejection and omitted for a match acceptance.

15. The method of claim 10, wherein the feedback image includes an outline corresponding to a border of the fingerprint pattern region of the segmented image.

16. The method of claim 15, wherein the visualization of the fingerprint pattern region includes a silhouette, and the outline of the feedback image is a border of the silhouette.

17. An electronic system for providing visual feedback during a process of sensing a fingerprint using a fingerprint sensor, the electronic system comprising:
a processing system configured to:
a) receive an image of the fingerprint from the fingerprint sensor;
b) segment the image of the fingerprint into a segmented image having a fingerprint pattern region and a non-fingerprint pattern region; and
c) generate a feedback image for rendering on a display device, wherein the feedback image includes a visualization of an imaging area of the fingerprint sensor and a visualization of at least the fingerprint pattern region of the segmented image, the visualization of the fingerprint pattern region positioned within the visualization of the imaging area at a location that corresponds to a position of the fingerprint relative to the imaging area of the fingerprint sensor.

18. The electronic system of claim 17, wherein the processing system is further configured to:
analyze a quality of the image of the fingerprint,
wherein the feedback image further includes a visualization of the quality of the fingerprint image.

19. The electronic system of claim 18, wherein the visualization of the quality includes a color coded representation of the quality.

20. The electronic system of claim 17, wherein the feedback image includes an outline corresponding to a border of the fingerprint pattern region of the segmented image.
